(19) United States
(12) Patent Application Publication
(10) Pub. No.: US 2025/0369478 A1
(43) Pub. Date: Dec. 4, 2025

(54) COMPOSITE MATERIAL ROLLING-ELEMENT BEARING CAGE HAVING HIGH INTERLAMINAR COHESION AND ASSOCIATED ROLLING-ELEMENT BEARING UNIT AND METHOD

(71) Applicants: AKTIEBOLAGET SKF, GOTEBORG (SE); SKF Aerospace France S.A.S, Perrigny (FR)

(72) Inventors: Thomas Bernd KRAUSE, Grafenrheinfeld (DE); Florian Vincent BARDY, Perrigny (FR); Feliciano GRECO, Cortemilia (IT); Federico DAL ZILIO, None (IT)

(21) Appl. No.: 19/211,367

(22) Filed: May 19, 2025

(30) Foreign Application Priority Data
May 29, 2024 (IT) 102024000012268

(51) Int. Cl. F16C 33/44

(52) U.S. Cl. CPC F16C 33/44

(57) ABSTRACT

A composite material rolling bearing cage includes an annular body having a plurality of pockets each configured to retain a rolling element body of a rolling bearing. The annular body has an axis of symmetry and an axial width, and the pockets are radially disposed around the annular body. The annular body is formed from a plurality of superimposed layers of reinforcing fibers embedded in a synthetic plastic material, the fibers of each layer of the plurality of layers are arranged at an angle to the axis of symmetry, and the angle to the axis of symmetry of the fibers in each layer is about 15° or less different than the angle to the axis of symmetry of the fibers in each immediately adjacent layer of the plurality of layers, “about” indicating a tolerance of ±3°.

### CROSS-REFERENCE

This application claims priority to Italian patent application no. 102024000012268 filed on May 29, 2024, the contents of which are fully incorporated herein by reference.

### TECHNOLOGICAL FIELD

The present disclosure is directed to a rolling bearing cage formed from a synthetic plastic resin, as well as to an associated rolling-element bearing unit including such a cage, the cage being formed from a fiber-reinforced composite synthetic plastic material. The disclosure also relates to a method for making a rolling bearing cage from a fiber reinforced composite synthetic plastic material with no (or strongly reduced) tendency to delaminate.

### BACKGROUND

As it is well known, a rolling-element bearing unit comprises a rolling bearing having an outer ring, an inner ring and a plurality of rolling bodies (for example balls) interposed between the inner and outer rings to make them relatively rotatable with low friction, and a rolling bearing cage to retain the rolling bodies in position, the cage being arranged in the radial space delimited between the inner ring and the outer ring.

A rolling bearing retaining cage comprises an annular body delimited between a radially inner and a radially outer cylindrical surface and a plurality of pockets or seats, each configured to house and retain in a freely rotatable manner a respective rolling body of the rolling bearing. The cage body is generally made of a synthetic plastic material, for example a phenolic resin or a polyamide or other suitable synthetic materials, and includes the pockets or seats, which are provided radially therethrough, e.g. in the form of passing-through radial holes (through openings radial holes).

Generally, a preform in the form of a hollow tube is obtained by molding the synthetic material, then the hollow tube is cut radially into a plurality of slices, each one of which can form a cage body. The pockets or seats are drilled through the cage body before or after the cutting operation.

However, to improve performances, is also know to form the cage body from a fiber-reinforced synthetic material, e.g. phenolic resins reinforced with cotton fibers embedded in the synthetic material matrix. In this case, the hollow tube constituting the preform may be produced by a process known as “continuous filament winding” (CFW), by tightly winding on a metal mandrel one or more filaments of composite material that include continuous fibers impregnated with a synthetic plastic resin.

Here and in the following, “plastic resin” it is to be understood to refer to either a thermoset or thermoplastic synthetic material. For example, the impregnation of fibers can either be made by a liquid thermoset resin or by a solid thermoplastic powder.

After a predetermined number of superimposed radial layers of pre-impregnated fibers are obtained, the preform is cured in a known manner to cause the consolidation of the synthetic material thereby impregnating the fibers in a solid matrix, in which the wound fibers remain embedded to constitute a reinforcing material. Curing may occur as disclosed, e.g., in FR 3053624 A1.

Fiber reinforced plastic cages, especially when obtained by CFW, are generally satisfactory. However, various factors may decrease their performance. For example, environmental humidity can have a negative impact on performance. Also, when the rolling bearing is subjected to high speed and high loads, this can cause the temperature of the cage in operation to increase close to, or over to, the glass transition temperature of the synthetic material that forms the matrix of the cage body.

### SUMMARY

To overcome such drawbacks a pending patent application of the present Applicant proposes to produce the cage body from a synthetic material having a glass transition temperature greater than or equal to 120° C., e.g. an epoxy resin, reinforced with high tensile strength and stiff fibers like carbon fibers, glass fiber, Kevlar® fibers and other known fibers having equivalent performances, in place of the traditional cotton fibers.

Though epoxy resin reinforced with long carbon fiber is a composite material commonly used for tooling intended to be subjected to stresses while in a static position, they are never, up to now, used for producing rolling bearing cages. even if they may bring considerable advantages.

For examples, when such a composite cage body is obtained via CFW methods it is possible to configure the preform tube with a sequence of carbon fiber layers oriented with different angles with respect to one another, in order both to prevent the composite preform tube from exhibiting a strong anisotropic behavior and to improve its mechanical properties and, accordingly, the mechanical properties of the final cage body.

However, by adopting such a kind of composite elements for realizing a moving component like a retaining cage of a rolling bearing, it has been found that once the composite material has been subjected to high centrifugal forces and to the characteristic hitting contact with the rolling bodies present in a bearing cage, the cage material tends to delaminate which causes a high increase of temperature in the application. Moreover, it has been noted that delamination may occur between the composite carbon fiber superimposed layers, especially due to, or during the, machining of the preform tube following its obtention and curing, to obtain therefrom a plurality of cage bodies by cutting radially the cured preform tube and drilling through it the pockets or seats to receive in use the rolling bodies.

The delamination problem may impair the performances of the CFW composite rolling bearing cages during use and, above all, may cause scraps during the production cycle, so increasing the production costs.

It is therefore an aspect of the present disclosure to overcome the foregoing problems and provide a composite material rolling bearing cage that has an improved service life and that maintains its mechanical properties in all use conditions. It is moreover an aim of the disclosure to provide a composite material rolling bearing cage having improved interlaminar cohesion, to avoid, or at least strongly limit, delamination in CFW composite material cages firstly during machining thereof and subsequently in operation under high rotational speed and high loads.

It is also an aim of the disclosure to provide a high precision rolling-element bearing unit equipped with a CFW composite material cage able to be employed in particularly stressful applications, like those requiring high rotation speeds and/or subjected to high loads.

It is finally an aim of the disclosure to provide a method for obtaining a rolling bearing cage made of a fiber reinforced synthetic plastic material substantially free from the delamination phenomenon.

### BRIEF DESCRIPTION OF THE DRAWINGS

Further characteristics and advantages of the present disclosure will become clear from the following description of non-limiting examples thereof, carried out with reference to the Figures of the attached drawings, in which:

FIG. 1 is a schematic side elevational view, partly in section, of a rolling-element bearing unit provided with a bearing cage made according to an embodiment of the disclosure.

FIG. 2 is a perspective view of the bearing cage of FIG. 1.

FIG. 3 is a side elevational view of a preform tube from which the bearing cage of FIG. 2 may be obtained mounted on a mandrel.

FIG. 4 is a schematic representation of a method for producing the bearing cage of FIG. 2.

FIG. 5 is a close-up perspective view of a portion of the preform tube of FIG. 3 from which some layers of composite material have been removed for illustration purposes.

FIG. 6 is a top plan view of the preform tube of FIG. 3 on which the winding angles of the applied reinforcing fibers are schematically shown.

### DETAILED DESCRIPTION

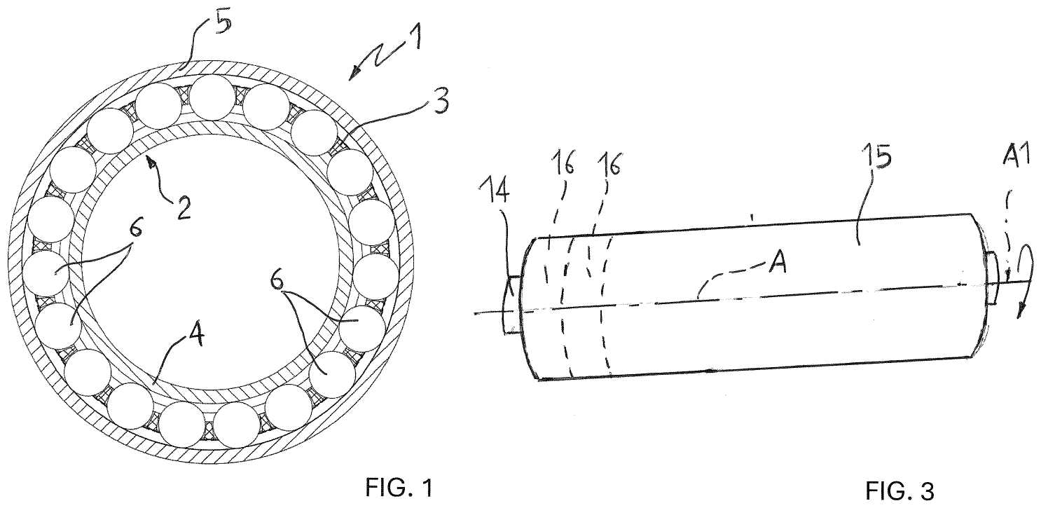

With reference to FIGS. 1-6, the reference number 1 indicates a rolling-element bearing unit (FIG. 1) comprising a rolling bearing 2 of any known type and a rolling bearing cage 3, made of a composite material. The rolling bearing comprises an inner ring 4, an outer ring 5 and a plurality of rolling elements or bodies 6, which in the non-limiting embodiment shown are balls.

The rolling bodies 6 are arranged, in the example shown, in one row of balls around an axis of symmetry A of the rolling bearing, which is also the axis of symmetry of cage 3. In different embodiments, not shown for sake of simplicity, the rolling bearing 2 may comprise two rows of rolling bodies arranged side by side and the rolling bodies may be without limitation, balls, cylindrical or conical rollers, or small cylinders, according to the operation necessity.

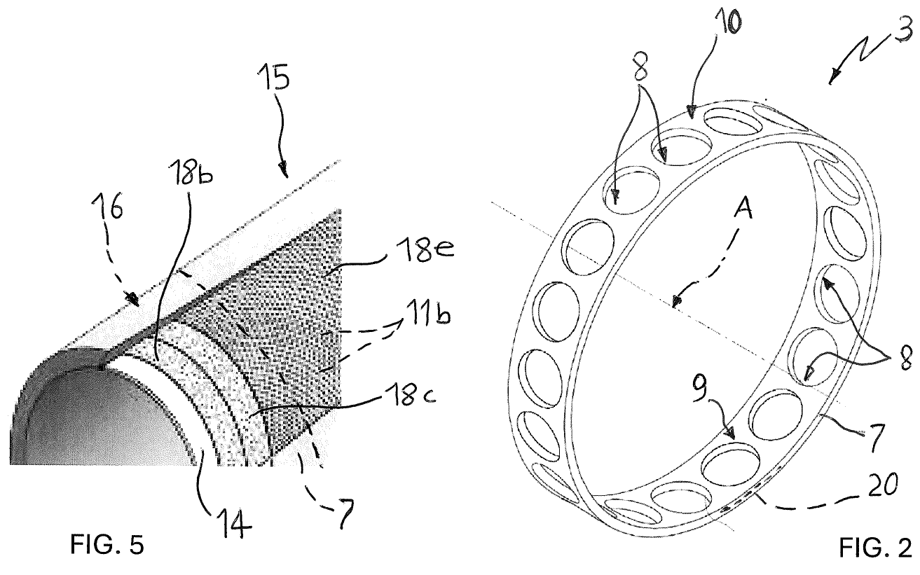

In any case, the rolling bearing cage 3 (FIG. 2) comprises an annular body 7 and a plurality of pockets or seats 8, each configured to freely house in use a respective rolling body 6 of the rolling bearing 2 to keep the rolling bodies 6 correctly spaced apart from one another by a prefixed pitch (or angular separation).

The annular body 7 has an axis of symmetry A and a prefixed axial width or length. The pockets or seats 8 are provided radially throughout the annular body 7, through respective inner and outer cylindrical surfaces 9 and 10 (FIG. 2) of the annular body 7, substantially perpendicularly thereto and, in the example shown, are simple cylindrical radial holes. The cylindrical surfaces 9 and 10 radially delimit the annular body 7 therebetween.

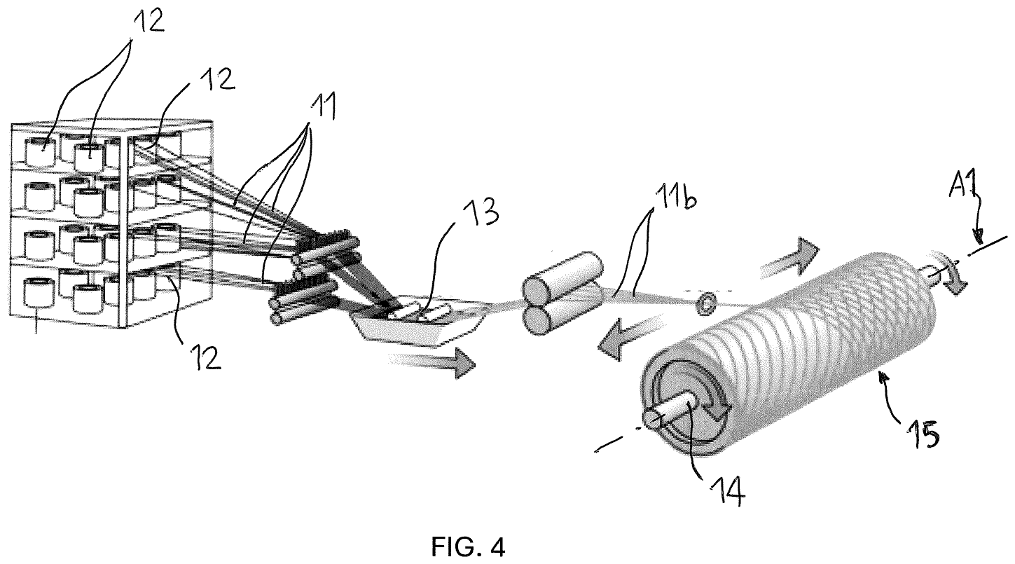

The annular body 7 is made of a fiber-reinforced synthetic plastic material and is produced by a method known in the art as continuous filament winding (CFW), schematically shown in a non-limiting manner in FIG. 4, merely for illustrative purposes and for a better understanding of the disclosure.

With reference to FIG. 4, in a CFW production method a plurality of reinforcing fibers 11 are unwound in known manner from spools 12, are impregnated in known manner with a synthetic resin/material, 13 and then the impregnated reinforcing fibers 11b are wound around a mandrel 14 with a prefixed inclination with respect to the axis of symmetry of mandrel 14, to obtain a preform tube 15 (FIGS. 3, 4 and 5). In the alternative, pre-peg (pre-impregnated) fibers or sheets of neatly ordered fibers may be used.

The axis of symmetry A1 of the mandrel 14 coincides with the axis of symmetry A of the cages 3 to be obtained therefrom and to the axis of winding of the fibers 11 around the mandrel 14.

To obtain a plurality of annular bodies 7 from a single preform tube 15, the preform tube 15 is cured in any known and suitable manner (e.g. according to the method disclosed in FR 3053624 A1), in order to polymerize the synthetic resin 13 to form a solid matrix, and then is cut radially in slices constituted each by an axial segment 16 of the preform tube 15 radially cut from the preform tube 15, e.g., along the dotted lines (FIGS. 3 and 5), so that each axial segment 16 of the preform tube 15 has the same axial width/length of a cage 3 to be obtained.

Before or after the cutting step, but generally after the curing step, a plurality of radial holes configured to be the pockets or seats 8 are drilled through each axial segment 16 of the preform tube 15. In alternative, the pockets or seats 8 may be obtained, still in known manner, during the winding step as shown in FIG. 4, by properly arranging the axial position of the fibers 11b and by providing the mandrel 14 with a plurality of radially outwardly projecting pins (not shown) each configured to cause a hole to form that corresponds to a pocket or seat 8 in the preform tube 15 directly during the formation of the preform tube 15.

Accordingly, as shown in FIG. 5, each segment 16 comes to constitute, after the cutting step, an annular body 7.

Each annular body 7, therefore, comprises a plurality of superimposed layers 18 of reinforcing fibers 11 embedded in a synthetic plastic material 13 and arranged with respect to the axis of symmetry A/A1 according to a prefixed pattern.

In some embodiments, the preform tube 15 may be formed from either a polymerized fiber reinforced thermoset resin or in a polymerized thermoplastic resin. In this latter case, the curing step of the preform tube 15 would be no longer necessary, since the thermoplastic powder for impregnating/embedding the fibers needs to be melted (and thus also polymerized) directly on the mandrel 14, e.g., by a laser beam or by a flux of hot air.

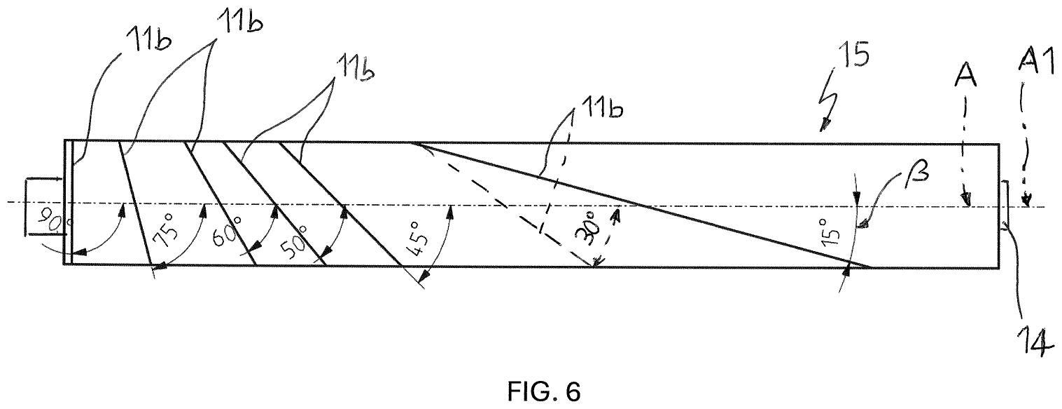

According to a first feature of the disclosure, the impregnated/embedded fibers 11b of each layer 18 form with the axis of symmetry A (FIG. 6) of the mandrel 14 an angle β, which differs from the angle β formed with the axis of symmetry A by the fibers 11b of each layer 18 immediately adjacent thereto by a value of about 15° or less, wherein the term “about” indicates a tolerance on the above angle value of +3°.

An example of the arrangement of the fibers 11b on the mandrel 14 in the different radially superimposed layers 18 is given schematically in FIG. 6, wherein a first, radially innermost layer 18b (FIG. 5) is formed with its impregnated fibers 11b arranged at an angle β of about 15° with respect to axis A, a second layer 18c (FIG. 5) immediately adjacent thereto is formed with its impregnated fibers 11b arranged at an angle β of about 30° with respect to axis A, a third layer 18e (FIG. 5) immediately adjacent layer 18c, radially on the outside thereof, is formed with its impregnated fibers 11b arranged at an angle β of about 45° with respect to axis A, and so on, up to arrange the fibers 11b at about 90° with respect to axis A.

Of course, after cutting the preform tube 15 into the axial stretches 16, the annular body 7 of each cage 3 that will be obtained by providing further the radial holes constituting the pockets or seats 8, will result in being formed, according to the disclosure, by a plurality of radially superimposed layers 18 of fibers 11b wound around the axis of symmetry A of the resulting cage 3 with the same pattern and angulation of winding β as obtained for the preform tube 15.

It is to be noted that fibers 11b may be wound around axis A according to a parallel or a crisscross pattern, so that angles β of each layer 18 may assume positive and/or negative value, e.g., the angle β of layer 18b may be +15° if fibers 11b are arranged as in FIG. 6 or may be −15° if fibers 11b are arranged in the opposite direction (e.g. converging towards axis A, from above axis A in FIG. 6, instead of from below axis A, as illustrated in FIG. 6).

According to a further feature of the disclosure, the composite material rolling bearing cage 3 is made using a synthetic plastic material which has, after curing, a glass transition temperature equal to, or greater than, 120° C., preferably an epoxy resin.

According to a further feature of the disclosure, the reinforcing fibers 11 are chosen in the group consisting of: carbon fibers, glass fibers, Kevlar® fibers, any synthetic fiber similar thereto for tensile strength and stiffness.

In some embodiments, the reinforcing fibers may be mineral fibers like basalt and quartz fibers and also ceramic fibers, like Al₂O₃ or SiC fibers and even in metal fibers like steel or aluminum fibers.

In some embodiments, the reinforcing fibers may be other organic fibers like cotton, cellulose, flax, jute, hemp and sisal fibers.

According to a preferred embodiment, the reinforcing fibers 11b are continuous fibers 11 embedded in the synthetic resin 13 which has been caused to impregnate the fibers 11.

According to a preferred embodiment, the impregnated fibers 11b are wound around the axis of symmetry A1 of mandrel 14 according to prefixed winding angles β, which angles β are arranged such that the angle which the fibers 11b of each layer 18 form with the axis of symmetry A of the final preform tube 15 correspond to the winding angle β thereto.

According to a preferred embodiment, the radially innermost layer 18b of the plurality of superimposed layers 18 presents the reinforcing fibers 11b thereof forming with the symmetry axis A of the annular body 7 (i.e. formed by an axial segment 16 of the preform tube 15) an angle β of about 15°, wherein about indicates a tolerance of =3°.

According to a most preferred embodiment, and proceeding in a radial direction starting from the radially innermost layer 18b, each subsequent layer 18 superimposed thereto has the reinforcing fibers 11/11b thereof having an inclination with respect to the axis of symmetry A/A1 increased of up to about 15° with respect to the inclination β of the reinforcing fibers 11/11b of the immediately adjacent layer 18 beneath it. Such sequence is followed up to reach a fiber inclination with respect to the symmetry axis A/A1 of about 90°.

The layer 18 at which the inclination of the fibers 11/11b with respect to axis A of the annular body 7 is about 90° may be the outermost layer 18 or, preferably, may be one of the intermediate layers 18 of the annular body 7, e.g., provided about a radial mid portion 20 thereof (shown only schematically and as a dotted line in FIG. 2 for sake of simplicity).

In the latter case, the radially superimposed layers 18 of body 7 arranged radially on the outside of the first intermediate layer at midportion 20 have the reinforcing fibers 11/11b thereof provided with an inclination with respect to the axis of symmetry A which decreases of up to about 15° with respect to the inclination of the reinforcing fibers 11/11b of the layer 18 arranged immediately adjacent beneath thereto.

According to one aspect of the disclosure, the rolling-element bearing unit 1 in FIG. 1 comprises therefore a rolling bearing, e.g., the rolling bearing 2 or any other model of rolling bearing having a plurality of rolling bodies 6 arranged in a radial space delimited between the inner ring 4 and the outer ring 5 to render them relatively rotatable with low friction, and a rolling bearing cage as described above for retaining the rolling bodies 6 spaced apart. The rolling bearing 2 is preferably of the high precision bearing type, characterized by high speed and/or high load of operation.

In fact, a rolling bearing cage 3 made according to what is described above, having care to provide the fibers 11/11b of each radially superimposed layer 18 forming the body 7 to be arranged with respect to the axis of symmetry A at an angle which differs from the angle formed with the axis of symmetry A by the fibers 11/11b of each layer 18 immediately adjacent thereto by a value of about 15° or less, surprisingly completely (or almost completely) avoids the phenomenon of delamination.

Investigations carried out by the designers of the Applicant showed that the nature of delamination was caused by the angle shift between each progressive layer 18 of reinforcing fibers, e.g., carbon fibers. In particular, when the angle shift between two consecutive layers 18 is higher than 15°, the cohesion between the two adjacent layers is lacking and delamination is highly probable.

It has been found that a shifting up to 15° of angled reinforcing fibers between two consecutive layers 18 is enough to prevent delamination in the component (e.g., a rolling bearing cage) even after execution of a running-in procedure, wherein the bearing has reached the maximum expected speed, which therefore validates the new design of the cage 3 as described in the present disclosure.

The main advantage of the present disclosure is preventing the cage from delaminating even under harsh conditions, which renders feasible the use of the epoxy resin with long carbon fiber reinforcements for producing a fiber reinforced synthetic cage for super precision angular contact ball bearings, what was not possible up to now.

Moreover, the disclosure reduces or even eliminate the risk of cage delamination between the different superimposed tape layers during operation, even in the case the cage is not obtained via a CFW process but anyway presents multiple fiber reinforced layers superimposed onto one another and having a parallel or crisscross fiber orientation in each superimposed layer.

From what described above, it is finally clear that the present disclosure also extends to a method for producing a composite material rolling bearing cage 3 comprising an annular body 7 and a plurality of pockets or seats 8 each configured to house in use a respective rolling body 6 of a rolling bearing 2, the annular body 7 having an axis of symmetry A and a prefixed axial width and the pockets or seats 8 being provided radially throughout the annular body 7, through respective inner and outer cylindrical radial surfaces 9, 10 of the annular body 7 radially delimiting the same. The method comprises the steps of: a) producing a preform tube 15 made of fiber reinforced synthetic plastic material by a continuous filament winding technique, by winding on a mandrel having an axis of symmetry coinciding with the axis of symmetry of the rolling bearing cage to be obtained, at least one continuous fiber of a high tensile strength and stiffness material impregnated with a synthetic resin having a glass transition temperature after curing of at least 120° C., preferably an epoxy resin, the fibers being preferably selected from the group consisting of: carbon fibers, glass fibers, Kevlar® fibers, mineral fibers like basalt and quartz fibers, ceramic fibers, e.g., Al2O3 or SiC fibers, metal fibers, e.g., steel or aluminum fibers, organic fibers including cotton, cellulose, flax, jute, hemp and sisal fibers, any synthetic, organic or inorganic fiber similar thereto in tensile strength and stiffness; b) curing the preform tube in order to polymerize the synthetic resin to form a synthetic plastic matrix in which the reinforcing fibers are embedded according to a prefixed pattern and forming with an axis of symmetry of the preform tube prefixed angles; c) radially cutting from the preform tube a plurality of axial segments thereof, each having an axial width identical to that of the rolling bearing cage to be obtained, each the axial segment of the preform tube having a plurality of pockets or seats provided therethrough and configured to house in use rolling bodies of a rolling bearing; the pocket or seats being obtained during step a) or being drilled in the preform tube after step b); wherein: d) in step a) the at least one continuous reinforcing fiber 11 is wound around the mandrel 14 to form a plurality of radially superimposed layers 18 of impregnated reinforcing fibers 11b, the fibers 11b of each layer 18 being wound with a winding angle forming with the axis of symmetry A1 of the mandrel 14 an angle β which differs from the angle β formed with the axis of symmetry A1 of the mandrel 14 by the fibers 11b of each layer 18 immediately adjacent thereto by a value of about 15° or less, wherein “about” indicates a tolerance of +3°. All the aims of the disclosure are therefore achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved composite material bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A composite material rolling bearing cage comprising:
an annular body having a plurality of pockets each configured to retain a rolling element body of a rolling bearing,
wherein the annular body has an axis of symmetry and an axial width,
wherein the pockets are radially disposed around the annular body,
wherein the annular body is formed from a plurality of superimposed layers of reinforcing fibers embedded in a synthetic plastic material,
wherein the fibers of each layer of the plurality of layers are arranged at an angle to the axis of symmetry,
wherein the angle to the axis of symmetry of the fibers in each layer is about 15° or less different than the angle to the axis of symmetry of the fibers in each immediately adjacent layer of the plurality of layers, wherein “about” indicates a tolerance of ±3°.

2. The composite material rolling bearing cage according to claim 1,
wherein the synthetic plastic material has a glass transition temperature after curing that is greater than or equal to 120° C.

3. The composite material rolling bearing cage according to claim 2,
wherein the synthetic plastic material is a thermoset resin or a thermoplastic resin.

4. The composite material rolling bearing cage according to claim 3,
wherein the synthetic plastic material is an epoxy resin.

5. The composite material rolling bearing cage according claim 4,
wherein the reinforcing fibers are selected from the group consisting of: carbon fibers, glass fibers, Kevlar® fibers, basalt fibers, quartz fibers, Al₂O₃ fibers, SiC fibers, steel fibers, aluminum fibers, cotton fibers, cellulose fibers, flax fibers, jute fibers, hemp fibers and sisal fibers.

6. The composite material rolling bearing cage according claim 4,
wherein the angle to the axis of symmetry of the fibers of a radially innermost layer of the plurality of layers is about 15°.

7. The composite material rolling bearing cage according claim 6,
wherein the angle to the axis of symmetry of at least one layer of the plurality of layers is about 90°.

8. The composite material rolling bearing cage according to claim 1,
wherein the angle to the axis of symmetry of the fibers in each layer is about 15° different than the angle to the axis of symmetry of the fibers in each immediately adjacent layer of the plurality of layers.

9. The composite material rolling bearing cage according to claim 8,
wherein the angle to the axis of symmetry of the fibers of a radially innermost layer of the plurality of layers is about 15°,
wherein the angle to the axis of symmetry of the fibers of a first layer immediately adjacent to the radially innermost layer is about 30°,
wherein the angle to the axis of symmetry of the fibers of a second layer immediately adjacent to the first layer is about 45°,
wherein the angle to the axis of symmetry of the fibers of a third layer immediately adjacent to the second layer is about 60°,
wherein the angle to the axis of symmetry of the fibers of a fourth layer immediately adjacent to the third layer is about 75°, and
wherein the angle to the axis of symmetry of the fibers of a fifth layer immediately adjacent to the fourth layer is about 90°.

10. The composite material rolling bearing cage according to claim 9,
wherein the angle to the axis of symmetry of the fibers of a sixth layer immediately adjacent to the fifth layer is about 75°.

11. A rolling-element bearing comprising:
an outer ring,
an inner ring,
a plurality of rolling bodies arranged in a radial space delimited between the inner ring and the outer ring, and
a rolling bearing cage according to claim 1 between the inner ring and the outer ring,
wherein one rolling body of the plurality of rolling bodies is located in each of the pockets.

12. A method for producing a composite material rolling bearing cage comprising an annular body and a plurality of pockets or seats each configured to house in use a respective rolling body of a rolling bearing, the annular body having an axis of symmetry and a predetermined axial width; the method comprising:
a) producing a preform tube made of fiber reinforced synthetic plastic material by a continuous filament winding technique, by winding on a mandrel having an axis of symmetry at least one continuous fiber impregnated with a synthetic resin having a glass transition temperature of at least 120° C. after curing, the at least one fiber being selected from the group consisting of: carbon fibers, glass fibers, Kevlar® fibers, basalt fibers, quartz fibers, Al₂O₃ fibers, SiC fibers, steel fibers, aluminum fibers, cotton fibers, cellulose fibers, flax fibers, jute fibers, hemp fibers and sisal fibers,
b) curing the preform tube to polymerize the synthetic resin to form a synthetic plastic matrix in which the reinforcing fibers are embedded according to a predetermined pattern and form predetermined angles with an axis of symmetry of the preform tube;
c) radially cutting a plurality of axial segments from the preform tube; and
d) forming a plurality of pockets in the axial segment,
wherein in step a) the at least one continuous reinforcing fiber is wound around the mandrel to form a plurality of radially superimposed layers, the fibers of each layer being wound with a winding angle relative to the axis of symmetry of the mandrel, the winding angle of each layer of the plurality of layers differing from the winding angle of the fibers of each layer immediately adjacent thereto by about 15° or less, wherein “about” indicates a tolerance of ±3°.

13. The method according to claim 11,
wherein the winding angle of the fibers of each layer of the plurality of layers differs from the winding angle of the fibers of each immediately layer adjacent by about 15°.
